(19) United States
(12) Patent Application Publication
(10) Pub. No.: US 2026/0146558 A1
(43) Pub. Date: May 28, 2026

(54) SOUNDPROOF DEVICE FOR DUCT AND INTAKE DUCT FOR COMPRESSOR OF GAS TURBINE

(71) Applicant: MITSUBISHI HEAVY INDUSTRIES, LTD., Tokyo (JP)

(72) Inventors: Tomohiro GOTO, Tokyo (JP); Keizo OHNISHI, Tokyo (JP)

(21) Appl. No.: 19/384,036

(22) Filed: Nov. 10, 2025

(30) Foreign Application Priority Data
Nov. 26, 2024 (JP) 2024-205314

(51) Int. Cl. F02C 7/045

(52) U.S. Cl. CPC F02C 7/045; F05D 2260/96

(57) ABSTRACT

A soundproof device for a duct according to at least one embodiment of the present disclosure is provided with: a first sound absorbing material disposed on one side of an outer wall member of the duct in a thickness direction of the outer wall member; a first fixing member to fix the first sound absorbing material to the outer wall member; a first plate member located on the one side of the first sound absorbing material with an air layer interposed therebetween; a second fixing member to fix the first plate member to the outer wall member; and a second sound absorbing material disposed on the one side of the first plate member.

### TECHNICAL FIELD

The present disclosure relates to a soundproof device for a duct and an intake duct for a compressor of a gas turbine.

The present application claims priority based on Japanese Patent Application No. 2024-205314 filed on Nov. 26, 2025, the entire content of which is incorporated herein by reference.

### BACKGROUND ART

Ducts through which fluid flows may be required to have a function to reduce noise and vibration from upstream and downstream of the fluid flow. For this reason, some ducts are equipped with sound absorbing materials (see, for example, Patent Document 1).

The duct described in Patent Document 1 is an intake duct for directing intake air to a compressor of a gas turbine, and a sound absorbing material is provided in the intake duct to reduce the transmission of the air intake sound generated by the compressor to the outside.

### CITATION LIST

### Patent Literature

Patent Document 1: JP2014-190253A

### SUMMARY

In recent years, the air intake noise generated by compressors has tended to increase due to the increasing size of gas turbines. In addition, there is a need to meet stricter standards for noise due to environmental regulations, etc., and it is desirable to improve the soundproof performance of ducts.

In view of the above, an object of at least one embodiment of the present disclosure is to provide a soundproof device for a duct and an intake duct for a compressor of a gas turbine whereby it is possible to improve the soundproof performance of the duct.
(1) A soundproof device for a duct according to at least one embodiment of the present disclosure is provided with: a first sound absorbing material disposed on one side of an outer wall member of the duct in a thickness direction of the outer wall member; a first fixing member to fix the first sound absorbing material to the outer wall member; a first plate member located on the one side of the first sound absorbing material with an air layer interposed therebetween; a second fixing member to fix the first plate member to the outer wall member; and a second sound absorbing material disposed on the one side of the first plate member.
(2) An intake duct for a compressor of a gas turbine according to at least one embodiment of the present disclosure is provided with a duct with the soundproof device having the above configuration (1) arranged such that a surface of the first plate member on the other side faces an inner side of the intake duct.

According to at least one embodiment of the present disclosure, it is possible to improve the soundproof performance of the duct.

### BRIEF DESCRIPTION OF DRAWINGS

FIG. 1 is a schematic diagram showing the overall configuration of a gas turbine.

FIG. 2 is a cross-sectional view taken along line II-II in FIG. 1 and shows a cross-section of a duct panel.

FIG. 3 is a cross-sectional view taken along line III-III in FIG. 2.

FIG. 4 is an enlarged view of section A in FIG. 2.

FIG. 5 is a perspective view of a connection member.

FIG. 6 is a diagram for describing a third fixing member.

FIG. 7 is a cross-sectional view taken along line VII-VII in FIG. 6.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

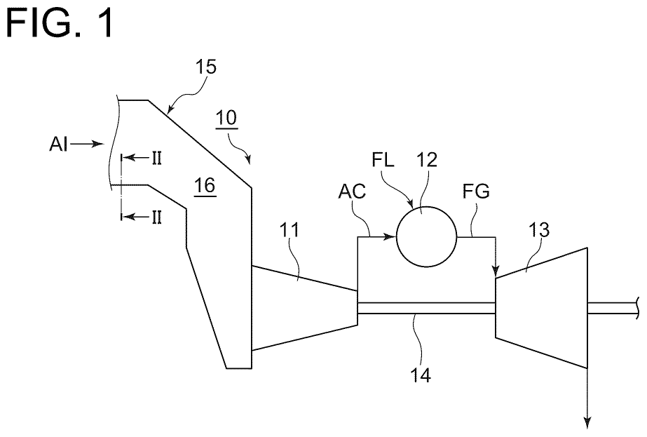

FIG. 1 is a schematic diagram showing the overall configuration of a gas turbine.

In the present embodiment, as shown in FIG. 1, a gas turbine 10 has an intake duct 15 and is configured such that a compressor 11, a combustor 12, and a turbine 13 are arranged coaxially on a rotor 14, and the rotor 14 is coupled at one end to a generator (not shown).

The compressor 11 generates high-temperature/high-pressure compressed air AC by compressing air AI taken in through the intake duct 15 from the air inlet as it passes through a plurality of stator vanes and rotor blades. The combustor 12 generates high-temperature/high-pressure combustion gas FG by supplying a predetermined fuel FL to the compressed air AC and burning the mixture. The turbine 13 drives the rotor 14 to rotate as the working fluid, the high-temperature/high-pressure combustion gas FG generated by the combustor 12, passes through a plurality of stator vanes and rotor vanes, thereby driving the generator (not shown) coupled to the rotor 14.

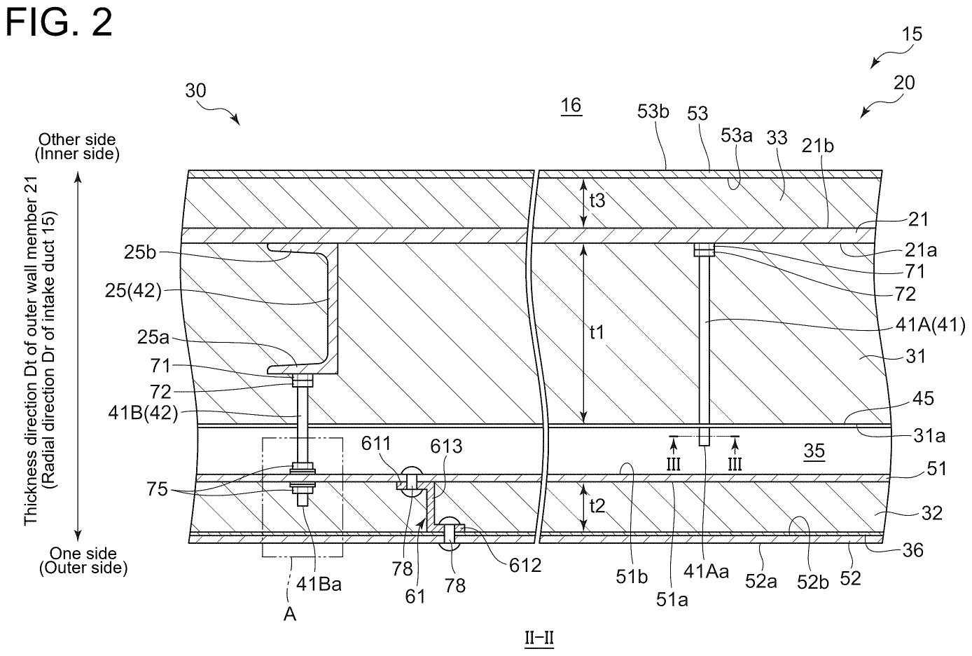

The intake duct 15 according to an embodiment is formed by combining a plurality of flat duct panels 20, including an outer wall member 21 and a soundproof device 30, which will be described below, provided in the outer wall member 21 as shown in FIGS. 2, 6, and 7.

FIG. 2 is a cross-sectional view taken along line II-II in FIG. 1 and shows a cross-section of the duct panel 20.

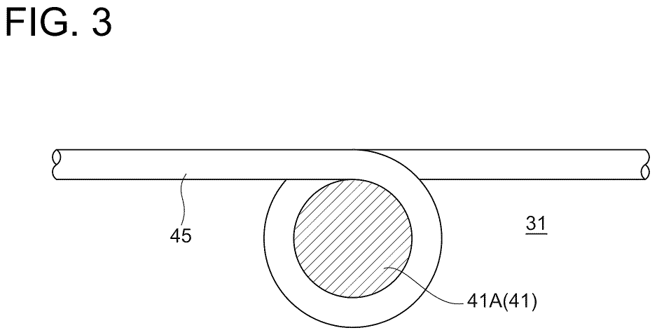

FIG. 3 is a cross-sectional view taken along line III-III in FIG. 2.

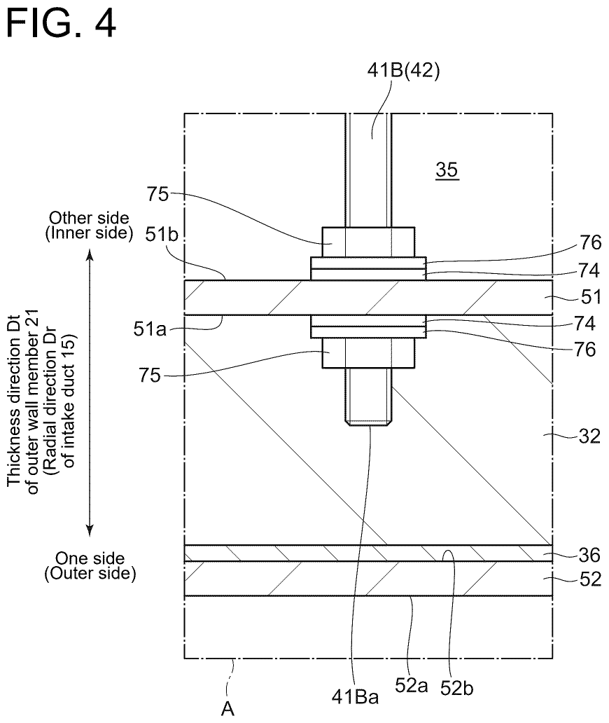

FIG. 4 is an enlarged view of section A in FIG. 2.

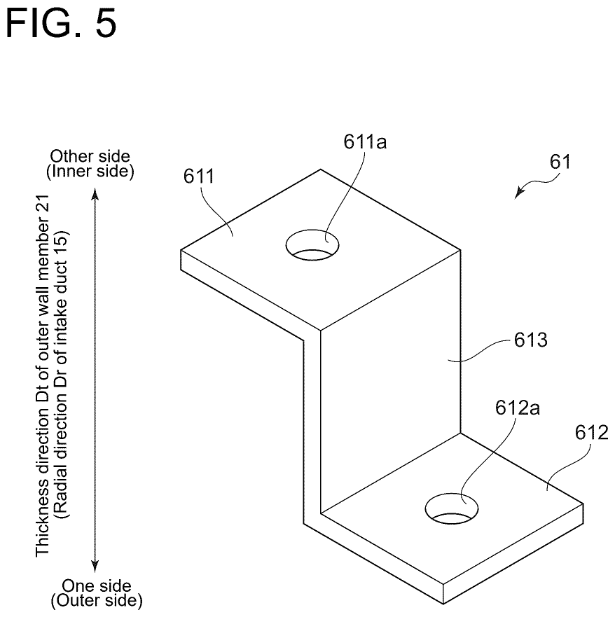

FIG. 5 is a perspective view of a connection member 61.

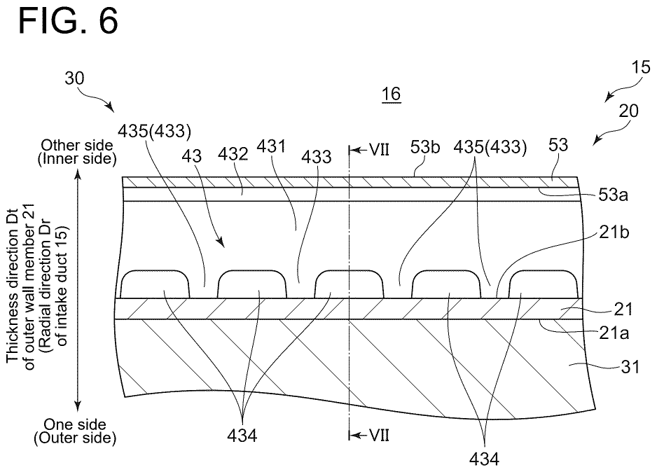

FIG. 6 is a cross-sectional view corresponding to the cross-section taken along line III-III in FIG. 2 to illustrate a third fixing member 43 for fixing a third sound absorbing material 33 to an outer wall member 21.

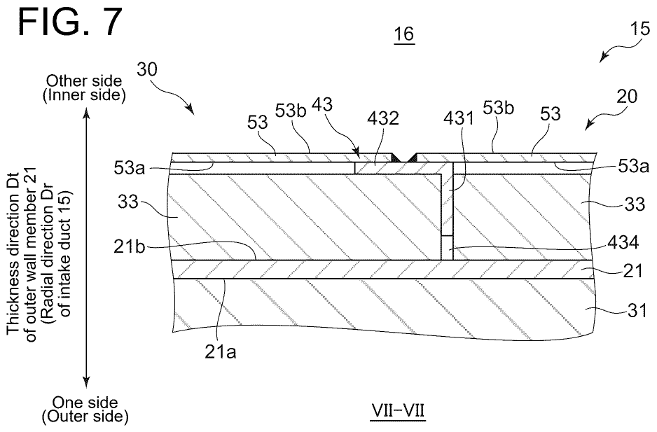

FIG. 7 is a cross-sectional view taken along line VII-VII in FIG. 6.

The soundproof device 30 for the intake duct 15 according to an embodiment is provided with: a first sound absorbing material 31 disposed on one side of the outer wall member 21 in the thickness direction Dt of the outer wall member 21; a first fixing member 41 to fix the first sound absorbing material 31 to the outer wall member 21; a first plate member 51 located on one side of the first sound absorbing material 31 in the thickness direction Dt with an air layer 35 interposed therebetween; a second fixing member 42 to fix the first plate member 51 to the outer wall member 21; and a second sound absorbing material 32 disposed on one side of the first plate member 51 in the thickness direction Dt.

Also, the soundproof device 30 for the intake duct 15 according to an embodiment may be provided with a second plate member 52 covering the second sound absorbing material 32 from one side in the thickness direction Dt, and a connection member 61 disposed between the first plate member 51 and the second plate member 52 to connect the first plate member 51 and the second plate member 52.

The soundproof device 30 for the intake duct 15 according to an embodiment may be provided with a sound insulation sheet 36 attached to the surface of the second plate member 52 on the other side in the thickness direction Dt.

The soundproof device 30 for the intake duct 15 according to an embodiment may be provided with: a third sound absorbing material 33 disposed on the other side of the outer wall member 21 in the thickness direction Dt; a third fixing member 43 extending in a direction perpendicular to the thickness direction Dt to fix the third sound absorbing material 33 to the outer wall member 21; and a third plate member 53 covering the third sound absorbing material 33 from the other side in the thickness direction Dt and fixed to the third fixing member 43.

In FIG. 6, the third sound absorbing material 33 is not depicted for the sake of descriptive convenience.

### Outer Wall Member 21 and Reinforcement Member 25

In the intake duct 15 according to an embodiment, the outer wall member 21 is a plate-like member extending in a direction perpendicular to the thickness direction Dt of the outer wall member 21, i.e., in a direction perpendicular to the thickness direction Dt along the plane of FIG. 2 and in the depth direction of the drawing. For the sake of descriptive convenience, the outer side in the radial direction Dr, which is centered on the flow direction of air AI in an air passage 16 inside the intake duct 15 (the extension direction of the intake duct 15), is defined as one side in the thickness direction Dt of the outer wall member 21, and the inner side in the radial direction Dr is defined as the other side in the thickness direction Dt.

In the intake duct 15 according to an embodiment, the air passage 16 is, for example, rectangular in cross-section perpendicular to the flow direction of air AI.

In the intake duct 15 according to an embodiment, the outer wall member 21 has a reinforcement member 25 attached to a surface 21a of the outer wall member 21 on one side in the thickness direction Dt and extending in a direction perpendicular to the thickness direction Dt.

This effectively reinforces the outer wall member 21.

In the example shown in FIG. 2, the reinforcement member 25 extends in the depth direction of FIG. 2, but it may extend in a direction different from the depth direction of FIG. 2 as long as it is perpendicular to the thickness direction Dt.

In the example shown in FIG. 2, the reinforcement member 25 has a C-shaped cross-section when viewed in the extension direction of the reinforcement member 25; however, shapes other than C-shaped, such as L-shaped, may also be used.

Although only one reinforcement member 25 is illustrated in FIG. 2, a plurality of reinforcement members 25 may be attached to the outer wall member 21 of one duct panel 20. The extension directions of the plurality of reinforcement members 25 may be the same or different.

### First Fixing Member 41

In the soundproof device 30 according to an embodiment, the first fixing member 41 serves to fix the first sound absorbing material 31 to the outer wall member 21, for example, a plurality of stud bolts 41A extending in the thickness direction Dt.

For example, as shown in the right area of FIG. 2, an end portion of the stud bolt 41A on the other side in the thickness direction Dt is fixed to the outer wall member 21 by so-called double-nut fastening with one nut 71 fixed, for example by welding, to the surface 21a of the outer wall member 21 on one side in the thickness direction Dt and another nut 72.

An end portion of the stud bolt 41A on one side in the thickness direction Dt protrudes from a surface 31a of the first sound absorbing material 31, which will be described below, on one side in the thickness direction Dt toward one side.

In other words, the first fixing member 41 passes through the first sound absorbing material 31 in the thickness direction Dt and restricts the movement of the first sound absorbing material 31 in a direction perpendicular to the thickness direction Dt.

The tip end 41Aa of the stud bolt 41A on one side in the thickness direction Dt is located on the other side of the first plate member 51, which will be described below, in the thickness direction Dt. In other words, the stud bolt 41A does not contact the first plate member 51, and the tip end 41Aa is in the air layer 35, which will be described below.

Therefore, in the soundproof device 30 according to an embodiment, vibration energy is unlikely to be transmitted between the first fixing member 41 and the first plate member 51.

The first fixing member 41 may be a bolt with a head instead of the stud bolt 41A as described above. If the first fixing member 41 is a head bolt, the head of the bolt should be fixed to the surface 21a of the outer wall member 21 on one side in the thickness direction Dt, for example, by welding.

### First Sound Absorbing Material 31

In the soundproof device 30 according to an embodiment, the first sound absorbing material 31 is disposed adjacent to the outer wall member 21 on one side in the thickness direction Dt of the outer wall member 21, as described above. The first sound absorbing material 31 is fixed to the first fixing member 41 as described above. In other words, the first sound absorbing material 31 is restricted from moving in a direction perpendicular to the thickness direction Dt by the first fixing member 41.

The first sound absorbing material 31 is restricted from moving to the other side in the thickness direction Dt by the outer wall member 21, which is located on the other side of the first sound absorbing material 31 in the thickness direction Dt.

Also, the first sound absorbing material 31 is restricted from moving to one side in the thickness direction Dt by a wire 45 located on one side of the first sound absorbing material 31 in the thickness direction Dt.

Specifically, as shown in FIG. 2, the wire 45 is in contact with the surface 31a of the first sound absorbing material 31 on one side in the thickness direction Dt and is fixed to the plurality of stud bolts 41A spaced apart from each other in a direction intersecting the thickness direction Dt. The wire 45 is secured to an end portion of each stud bolt 41A on one side in the thickness direction Dt by being wound around the stud bolt 41A, for example, as shown in FIG. 3.

The dimension of the first sound absorbing material 31 in the thickness direction Dt, i.e., thickness t1 of the first sound absorbing material 31, is larger than the dimension of the second sound absorbing material 32 in the thickness direction Dt, i.e., thickness t2 of the second sound absorbing material 32, which will be described below.

With this configuration, since the thickness t2 of the second sound absorbing material 32, which is located farther from the outer wall member 21 than the first sound absorbing material 31, is smaller than the thickness t1 of the first sound absorbing material 31, the weight of the structure for fixing the second sound absorbing material 32 to the outer wall member 21 can be reduced, and the weight of the soundproof device 30 can be reduced.

The structure for fixing the second sound absorbing material 32 to the outer wall member 21 includes the second fixing member 42, the first plate member 51, the connection member 61, and the second plate member 52, which will be described below. If the thickness t2 of the second sound absorbing material 32 is small, in the structure, the bending strength of a stud bolt 41B, which is included in the second fixing member 42 as described below, can be reduced, and the weight of the stud bolt 41B can be reduced.

The thickness t1 of the first sound absorbing material 31 is larger than the dimension of the third sound absorbing material 33 in the thickness direction Dt, i.e., thickness t3 of the third sound absorbing material 33, which will be described below.

With this configuration, it is possible to reduce the dimension from the outer wall member 21 to the other side in the thickness direction Dt while effectively reducing the noise and vibration transmitted through the soundproof device 30 in the thickness direction Dt.

For example, in the case where the soundproof device 30 according to an embodiment is used for the intake duct 15, the dimension from the outer wall member 21 to the inner side in the radial direction Dr of the intake duct 15 can be reduced. This makes it easier to secure the cross-sectional area of the air passage 16, thus reducing the effect on the intake air volume.

### Air Layer 35

In the soundproof device 30 according to an embodiment, the air layer 35 is an empty space between the surface 31a of the first sound absorbing material 31 on one side in the thickness direction Dt and the first plate member 51, which will be described below. In other words, the first sound absorbing material 31 is spaced apart from the first plate member 51 in the thickness direction Dt.

### First Plate Member 51

In the soundproof device 30 according to an embodiment, the first plate member 51 is a plate-like member extending in a direction perpendicular to the thickness direction Dt, i.e., in a direction perpendicular to the thickness direction Dt along the plane of FIG. 2 and in the depth direction of the drawing. The first plate member 51 is fixed to the outer wall member 21 by the second fixing member 42, which will be described below, at a distance on one side in the thickness direction Dt from the surface 31a of the first sound absorbing material 31 on one side in the thickness direction Dt.

### Second Fixing Member 42

In the soundproof device 30 according to an embodiment, the second fixing member 42 serves to fix the first plate member 51 to the outer wall member 21 as described above, and includes a plurality of stud bolts 41B extending in the thickness direction Dt and the reinforcement member 25 described above.

The reinforcement member 25 is attached at an end portion 25b on the other side in the thickness direction Dt to the surface 21a of the outer wall member 21 on one side in the thickness direction Dt, as described above. An end portion of the stud bolt 41B on the other side in the thickness direction Dt is attached to an end portion 25a of the reinforcement member 25 on one side in the thickness direction Dt. Specifically, the end portion of the stud bolt 41B on the other side in the thickness direction Dt is fixed to the end portion 25a of the reinforcement member 25 on one side by so-called double-nut fastening with one nut 71 fixed, for example by welding, to the end portion 25a of the reinforcement member 25 on one side and another nut 72.

With this configuration, the length of the stud bolt 41B in the thickness direction Dt can be made relatively short, and the weight of the stud bolt 41B can be reduced, so that the weight of the soundproof device 30 can be reduced.

For example, as shown in FIG. 4, on one side in the thickness direction Dt of the stud bolt 41B, which is fixed to the outer wall member 21 via the reinforcement member 25 as described above, the first plate member 51 is fixed to the stud bolt 41B by nuts 75 via elastic members on both a surface 51a on one side in the thickness direction Dt and a surface 51b on the other side in the thickness direction Dt. In other words, the first plate member 51 is sandwiched between washers 74 made of elastic material that can absorb vibration, such as rubber, on the surface 51a on one side in the thickness direction Dt and the surface 51b on the other side in the thickness direction Dt. The first plate member 51 is further sandwiched between a nut 75 disposed on one side of the washer 74 on one side in the thickness direction Dt and a nut 75 disposed on the other side of the washer 74 on the other side in the thickness direction Dt, thereby being fixed to the stud bolt 41B via the elastic members.

With this configuration, it is possible to reduce the vibration energy transmitted between the stud bolt 41B and the first plate member 51.

A metal washer 76 may be disposed between the washer 74, which is made of elastic material, and the nut 75.

The stud bolt 41B of the second fixing member 42 may be a bolt with a head. In this case, the head of the bolt should be fixed to the end portion 25a of the reinforcement member 25 on one side, for example, by welding.

The tip end 41Ba of the stud bolt 41B on one side in the thickness direction Dt may be located on the other side of the second plate member 52 in the thickness direction Dt at a distance from the second plate member 52.

With this configuration, it is possible to reduce the vibration energy transmitted between the second fixing member 42 and the second plate member 52.

### Second Sound Absorbing Material 32

In the soundproof device 30 according to an embodiment, the second sound absorbing material 32 is disposed adjacent to the first plate member 51 on one side in the thickness direction Dt. The second sound absorbing material 32 is restricted from moving to the other side in the thickness direction Dt by the first plate member 51, and from moving to one side in the thickness direction Dt by the second plate member 52, which will be described below. The second sound absorbing material 32 is restricted from moving in a direction perpendicular to the thickness direction Dt by the connection member 61, which will be described below.

### Connection Member 61

In the soundproof device 30 according to an embodiment, the connection member 61 is a plurality of members for connecting the first plate member 51 to the second plate member 52, which is disposed on one side of the first plate member 51 in the thickness direction Dt at a distance. As shown in FIG. 5, the connection member 61 is a Z-shaped plate material that includes a first part 611 extending along the surface 51a of the first plate member 51 on one side in the thickness direction Dt, a second part 612 extending along the surface 52b of the second plate member 52 on the other side in the thickness direction Dt, and a third part 613 extending between the first part 611 and the second part 612 along the thickness direction Dt.

For example, the connection member 61 has a through hole 611a that penetrates the first part 611 in the thickness direction Dt and a through hole 612a that penetrates the second part 612 in the thickness direction Dt.

The connection member 61 is joined at the first part 611 to the first plate member 51 by a rivet 78 or screw part inserted in the through hole 611a and is joined at the second part 612 to the second plate member 52 by a rivet 78 or screw part inserted in the through holes 612a.

With this configuration, the first plate member 51 and the second plate member 52 can be joined to the connection member 61 with a relatively simple configuration.

The connection member 61 also functions to restrict the movement of the second sound absorbing material 32 in a direction perpendicular to the thickness direction Dt, as described above.

In the soundproof device 30 according to an embodiment, the number of connection members 61 arranged may be not more than ten per square meter of the first plate member 51, preferably not more than six per square meter, more preferably not more than three per square meter.

As described below, the connection members 61 can serve as a path for transmitting vibration energy between the first plate member 51 and the second plate member 52. Therefore, by setting the number of connection members 61 as described above, the transmission path of vibration energy between the first plate member 51 and the second plate member 52 can be relatively reduced, and the vibration, etc., transmitted between the first plate member 51 and the second plate member 52 can be reduced.

### Second Plate Member 52 and Sound Insulation Sheet 36

In the soundproof device 30 according to an embodiment, the second plate member 52 is a plate-like member extending in a direction perpendicular to the thickness direction Dt, i.e., in a direction perpendicular to the thickness direction Dt along the plane of FIG. 2 and in the depth direction of the drawing, which is located on one side of the first plate member 51 in the thickness direction Dt at a distance from the first plate member 51 and covers the second sound absorbing material 32 from one side in the thickness direction Dt, as described above. The second plate member 52 is fixed to the first plate member 51 via the connection member 61, as described above.

In the soundproof device 30 according to an embodiment, a sound insulation sheet 36 may be attached to the surface 52b of the second plate member 52 on the other side in the thickness direction Dt. The sound insulation sheet 36 is a sheet of flexible rubber or other material, for example, and may contain metal powder to increase the weight per unit volume.

This makes the second plate member 52 less prone to vibrate, reducing the noise emitted by vibration of the second plate member 52. Additionally, since the attached sound insulation sheet 36 makes the second plate member 52 less prone to vibrate, it is possible to reduce the vibration energy transmitted from the second plate member 52 to the other side in the thickness direction Dt.

### Third Sound Absorbing Material 33

In the soundproof device 30 according to an embodiment, as shown in FIGS. 2 and 7, the third sound absorbing material 33 is disposed adjacent to the outer wall member 21 on the other side in the thickness direction Dt, as described above. The third sound absorbing material 33 is restricted from moving to one side in the thickness direction Dt by the outer wall member 21, and from moving to the other side in the thickness direction Dt by the third plate member 53, which is fixed to the third fixing member 43 as described below. The third sound absorbing material 33 is restricted from moving in a direction perpendicular to the thickness direction Dt by the third fixing member 43.

### Third Fixing Member 43

In the soundproof device 30 according to an embodiment, as shown in FIGS. 6 and 7, the third fixing member 43 is attached to the other side of the outer wall member 21 in the thickness direction Dt and extends in a direction perpendicular to the thickness direction Dt.

In the example shown in FIG. 6, the third fixing member 43 extends in the left-right direction of FIG. 6, but it may extend in a direction different from the left-right direction of FIG. 6 as long as it is perpendicular to the thickness direction Dt.

Although only one third fixing member 43 is illustrated in FIGS. 6 and 7, a plurality of third fixing members 43 may be attached to the outer wall member 21 of one duct panel 20. The extension directions of the plurality of third fixing members 43 may be the same or different.

In the soundproof device 30 according to an embodiment, the third fixing member 43 includes a plate-like first part 431 extending in the thickness direction Dt.

The third fixing member 43 may include a second part 432 that protrudes, in a direction (the left-right direction of FIG. 7) perpendicular to both the extension direction of the third fixing member 43 (the depth direction of FIG. 7) and the thickness direction Dt, from an end portion of the first part 431 on the other side in the thickness direction Dt of both end portions in the thickness direction Dt, as shown in FIG. 7, for example.

In the example shown in FIG. 7, the second part 432 protrudes from the end portion of the first part 431 on the other side in the thickness direction Dt toward one side (the left side of FIG. 7) in the direction (the left-right direction of FIG. 7) perpendicular to the thickness direction Dt, but it may also protrude toward the other side (the right side of FIG. 7) in the direction (the left-right direction of FIG. 7) perpendicular to the thickness direction Dt. That is, the third fixing member 43 may be L-shaped as shown in FIG. 7, or T-shaped in cross-section when viewed in the extension direction of the third fixing member 43.

In the third fixing member 43 of the soundproof device 30 according to an embodiment, the first part 431 has a connection portion 433 where the third fixing member 43 (first part 431) and the outer wall member 21 are connected and a non-connection portion 434 where the third fixing member 43 (first part 331) and the outer wall member 21 are not connected, which are arranged alternately along the extension direction of the third fixing member 43 (the left-right direction of FIG. 6, the depth direction of FIG. 7).

The third fixing member 43 is fixed to the surface 21b of the outer wall member 21 on the other side in the thickness direction Dt at the connection portion 433, for example, by welding.

In the soundproof device 30 according to an embodiment, the connection portion 433 of the third fixing member 43 is a plurality of projections 435 arranged on the third fixing member 43 (first part 431) at intervals along the extension direction of the third fixing member 43 (the left-right direction of FIG. 6, the depth direction of FIG. 7) and protruding toward one side in the thickness direction Dt.

The projections 435, i.e., the connection portions 433, and the first part 431 on the other side of the connection portions 433 in the thickness direction Dt may have the same dimension in the depth direction of FIG. 6 (the left-right direction of FIG. 7), or the connection portions 433 may be smaller than the first part 431 on the other side of the connection portions 433 in the thickness direction Dt.

### Third Plate Member 53

In the soundproof device 30 according to an embodiment, the third plate member 53 is a plate-like member extending in a direction perpendicular to the thickness direction Dt, i.e., in the left-right direction and the depth direction of FIG. 6. As shown in FIG. 7, the third plate member 53 covers the third sound absorbing material 33 from the other side in the thickness direction Dt as described above. The third plate member 53 is fixed, for example at its edge, to the second part 432 of the third fixing member 43, for example, by welding.

### Noise and Vibration Transmission Path

In the soundproof device 30 according to an embodiment with such configuration, noise and vibration are reduced in the process of being transmitted in the thickness direction Dt as described below. The following describes the case where noise and vibration are transmitted from the other side to one side in the thickness direction Dt, but the same applies to the case where noise and vibration are transmitted from one side to the other side in the thickness direction Dt, so a detailed explanation will be omitted.

In the soundproof device 30 according to an embodiment, noise and vibration (hereinafter referred to as vibration, etc.) from the other side to one side in the thickness direction Dt is first transmitted to the third plate member 53 from the area on the other side of the third plate member 53 in the thickness direction Dt. In the case where the soundproof device 30 according to an embodiment is used for the intake duct 15, vibration, etc., from the other side to one side in the thickness direction Dt is first transmitted from the air passage 16 to the third plate member 53.

Vibration, etc., reaching the third plate member 53 is transmitted to the outer wall member 21 while being attenuated by the third sound absorbing material 33.

Also, vibration, etc., reaching the third plate member 53 is transmitted to the outer wall member 21 via the third fixing member 43. In this case, vibration, etc., transmitted from the third fixing member 43 to the outer wall member 21 is transmitted from the connection portion 433 in the first part 431 of the third fixing member 43 to the outer wall member 21. In the soundproof device 30 according to an embodiment, since the first part 431 of the third fixing member 43 has alternating connection portions 433 and non-connection portions 434 along the extension direction of the third fixing member 43, the transmission of vibration, etc., between the third fixing member 43 and the outer wall member 21 is reduced, so that the vibration, etc., transmitted in the thickness direction Dt of the outer wall member 21 is effectively reduced.

In the soundproof device 30 according to an embodiment, as described above, the connection portion 433 of the third fixing member 43 is a plurality of projections 435 arranged on the third fixing member 43 (first part 431) at intervals along the extension direction of the third fixing member 43 and protruding toward one side in the thickness direction Dt.

This allows the transmission of vibration, etc., between the third fixing member 43 and the outer wall member 21 to be reduced by a relatively simple configuration, effectively reducing the vibration, etc., transmitted in the thickness direction Dt of the outer wall member 21.

Additionally, in the soundproof device 30 according to an embodiment, since the third fixing member 43 is fixed to the outer wall member 21 at the plurality of connection portions 433, which are the plurality of projections 435 protruding toward one side in the thickness direction Dt, it is possible to effectively reduce the possibility of the third fixing member 43 detaching from the outer wall member 21.

For example, in the case where the soundproof device 30 according to an embodiment is used for the intake duct 15, if the third fixing member 43 were to detach from the outer wall member 21, the third fixing member 43, the third plate member 53, or the third sound absorbing material 33 would enter the compressor 11, causing damage to the compressor 11.

In this regard, the soundproof device 30 according to an embodiment effectively reduces the possibility of the third fixing member 43 detaching from the outer wall member 21 as described above, thus reducing the possibility of damage to the compressor 11.

In the soundproof device 30 according to an embodiment, vibration, etc. transmitted to the outer wall member 21 from the other side in the thickness direction Dt as described above is reduced by the first sound absorbing material 31 and the air layer 35 in the process of being transmitted to the first plate member 51.

As described above, since the stud bolt 41A does not contact the first plate member 51 and the tip end 41Aa is in the air layer 35, the vibration, etc. is less likely to be transmitted between the stud bolt 41A and the first plate member 51.

Further, as described above, the first plate member 51 is fixed to the stud bolt 41B, with the surface 51a on one side in the thickness direction Dt and the surface 51b on the other side in the thickness direction Dt being sandwiched between the washers 74 made of elastic material. Therefore, vibration, etc. transmitted from the outer wall member 21 to the first plate member 51 via the reinforcement member 25 and the stud bolt 41B is attenuated and reduced by the washers 74 made of elastic material.

In the soundproof device 30 according to an embodiment, vibration, etc. transmitted to the first plate member 51 from the other side in the thickness direction Dt as described above is reduced by the second sound absorbing material 32 in the process of being transmitted to the second plate member 52.

Although the first plate member 51 and the second plate member 52 are connected by the connection member 61, since the connection member 61 is a Z-shaped plate material, the transmission path of vibration, etc. between the first plate member 51 and the second plate member 52 is relatively complex. As a result, vibration, etc. transmitted from the first plate member 51 to the second plate member 52 is reduced.

Thus, in the soundproof device 30 according to an embodiment, the first sound absorbing material 31 and the second sound absorbing material 32, which is disposed on one side of the first sound absorbing material 31 with the air layer 35 interposed therebetween in the thickness direction Dt, effectively reduce vibration, etc. transmitted through the soundproof device 30 in the thickness direction Dt.

The intake duct 15 according to an embodiment is an intake duct 15 in which the soundproof device 30 according to the above-described embodiments is arranged such that the surface 51b of the first plate member 51 on the other side in the thickness direction Dt faces the inside of the intake duct 15 in the radial direction Dr.

This effectively reduces the transmission of the air intake sound generated by the compressor 11 to the outside.

In the intake duct 15 formed as described above, the surface 53b of the third plate member 53 on the other side in the thickness direction Dt forms the inner surface of the intake duct 15 in the radial direction Dr and faces the air passage 16 inside the intake duct 15. In the intake duct 15 formed as described above, the surface 52a of the second plate member 52 on one side in the thickness direction Dt forms the outer surface of the intake duct 15 in the radial direction Dr and faces the outside of the intake duct 15.

The present disclosure is not limited to the embodiments described above, but includes modifications to the embodiments described above, and embodiments composed of combinations of those embodiments.

For example, in the soundproof device 30 according to the above-described embodiments, the sound insulation sheet 36 is attached to the surface 52b of the second plate member 52 on the other side in the thickness direction Dt, but it may be attached to a surface other than the surface 52b of the second plate member 52 on the other side in the thickness direction Dt. Specifically, the sound insulation sheet 36 may be attached not only to the surface 52b of the second plate member 52 on the other side in the thickness direction Dt, but also to at least one of the surface 51a of the first plate member 51 on one side in the thickness direction Dt, the surface 51b of the first plate member 51 on the other side in the thickness direction Dt, the surface 21a of the outer wall member 21 on one side in the thickness direction Dt, the surface 21b of the outer wall member 21 on the other side in the thickness direction Dt, and the surface 53a of the third plate member 53 on one side in the thickness direction Dt.

In the soundproof device 30 according to the above-described embodiment, a vibration-damping steel plate may be used instead of the second plate member 52 to which the sound insulation sheet 36 is attached. The vibration-damping steel plate is a member having a structure in which rubber, resin, or other material is sandwiched between two metal plates.

In the soundproof device 30 according to the above-described embodiment, a vibration-damping steel plate may be used not only for the second plate member 52, but also for at least any one of the first plate member 51, the outer wall member 21, and the third plate member 53.

The contents described in the above embodiments would be understood as follows, for instance.
(1) A soundproof device 30 for a duct according to at least one embodiment of the present disclosure is provided with: a first sound absorbing material 31 disposed on one side of an outer wall member 21 of the duct (intake duct 15) in the thickness direction Dt of the outer wall member 21; a first fixing member 41 to fix the first sound absorbing material 31 to the outer wall member 21; a first plate member 51 located on the one side of the first sound absorbing material 31 in the thickness direction Dt with an air layer 35 interposed therebetween; a second fixing member 42 to fix the first plate member 51 to the outer wall member 21; and a second sound absorbing material 32 disposed on the one side of the first plate member 51 in the thickness direction Dt.

With the above configuration (1), the first sound absorbing material 31 and the second sound absorbing material 32, which is disposed on one side of the first sound absorbing material 31 with the air layer 35 interposed therebetween in the thickness direction Dt, effectively reduce the noise and vibration transmitted through the soundproof device 30 for the duct in the thickness direction Dt.
(2) In some embodiments, in the above configuration (1), the soundproof device may be provided with: a second plate member 52 covering the second sound absorbing material 32 from the one side in the thickness direction Dt; and a connection member 61 disposed between the first plate member 51 and the second plate member 52 to connect the first plate member 51 and the second plate member 52. The connection member 61 may be a Z-shaped plate material that includes a first part 611 extending along a surface 51a of the first plate member 51 on the one side in the thickness direction Dt, a second part 612 extending along a surface 52b of the second plate member 52 on the other side in the thickness direction Dt, and a third part 613 extending between the first part 611 and the second part 612 along the thickness direction Dt.

With the above configuration (2), the transmission path of vibration energy between the first plate member 51 and the second plate member 52 is relatively complex, so that the vibration energy transmitted between the first plate member 51 and the second plate member 52 can be reduced.
(3) In some embodiments, in the above configuration (2), the first plate member 51 and the first part 611 may be joined by a screw part or a rivet 78, and the second plate member 52 and the second part 612 may be joined by a screw part or a rivet 78.

With the above configuration (3), the first plate member 51 and the second plate member 52 can be joined to the connection member 61 with a relatively simple configuration.
(4) In some embodiments, in the above configuration (2) or (3), the number of the connection members 61 arranged may be not more than three per square meter of the first plate member 51.

With the above configuration (4), the transmission path of vibration energy between the first plate member 51 and the second plate member 52 can be relatively reduced, so that the vibration energy transmitted between the first plate member 51 and the second plate member 52 can be reduced.
(5) In some embodiments, in any one of the above configurations (2) to (4), the soundproof device may be provided with a sound insulation sheet 36 attached to the surface 52b of the second plate member 52 on the other side in the thickness direction Dt.

With the above configuration (5), since the attached sound insulation sheet 36 makes the second plate member 52 less prone to vibrate, it is possible to reduce the noise emitted by vibration of the second plate member 52. Additionally, with the above configuration (5), since the attached sound insulation sheet 36 makes the second plate member 52 less prone to vibrate, it is possible to reduce the vibration energy transmitted from the second plate member 52 to the other side in the thickness direction Dt.
(6) In some embodiments, in any one of the above configurations (2) to (5), the second fixing member 42 may include a bolt (stud bolt 41B) extending in the thickness direction Dt. An end portion (tip end 41Ba) of the bolt (stud bolt 41B) on the one side in the thickness direction Dt may be located on the other side of the second plate member 52 in the thickness direction Dt at a distance from the second plate member 52.

With the above configuration (6), it is possible to reduce the vibration energy transmitted between the second fixing member 42 and the second plate member 52.
(7) In some embodiments, in any one of the above configurations (1) to (6), the soundproof device may be provided with a reinforcement member 25 attached to the one side of the outer wall member 21 in the thickness direction Dt and extending in a direction perpendicular to the thickness direction Dt.

With the above configuration (7), the outer wall member 21 is effectively reinforced.
(8) In some embodiments, in the above configuration (7), the second fixing member 42 may include a bolt (stud bolt 41B) extending in the thickness direction Dt and the reinforcement member 25. An end portion of the bolt (stud bolt 41B) on the other side in the thickness direction Dt may be fixed to the reinforcement member 25.

With the above configuration (8), the length of the bolt (stud bolt 41B) in the thickness direction Dt can be made relatively short, and the weight of the bolt (stud bolt 41B) can be reduced, so that the weight of the soundproof device 30 for the duct can be reduced.
(9) In some embodiments, in any one of the above configurations (1) to (8), the second fixing member 42 may include a bolt (stud bolt 41B) extending in the thickness direction Dt. The first plate member 51 may be fixed to the bolt (stud bolt 41B) by nuts 75 via elastic members (washers 74) on both a surface 51a on the one side in the thickness direction Dt and a surface 51b on the other side in the thickness direction Dt.

With the above configuration (9), it is possible to reduce the vibration energy transmitted between the bolt (stud bolt 41B) and the first plate member 51.
(10) In some embodiments, in any one of the above configurations (1) to (9), a dimension (thickness t1) of the first sound absorbing material 31 in the thickness direction Dt may be larger than a dimension (thickness t2) of the second sound absorbing material 32 in the thickness direction Dt.

With the above configuration (10), since the thickness t2 of the second sound absorbing material 32, which is located farther from the outer wall member 21 than the first sound absorbing material 31, is smaller than the thickness t1 of the first sound absorbing material 31, the weight of the structure for fixing the second sound absorbing material 32 to the outer wall member 21 can be reduced, and the weight of the soundproof device 30 for the duct can be reduced.
(11) In some embodiments, in any one of the above configurations (1) to (10), the soundproof device may be provided with: a third sound absorbing material 33 disposed on the other side of the outer wall member 21 in the thickness direction Dt; a third fixing member 43 extending in a direction perpendicular to the thickness direction Dt to fix the third sound absorbing material 33 to the outer wall member 21; and a third plate member 53 covering the third sound absorbing material 33 from the other side in the thickness direction Dt and fixed to the third fixing member 43. The third fixing member 43 may have a connection portion 433 where the third fixing member 43 and the outer wall member 21 are connected and a non-connection portion 434 where the third fixing member 43 and the outer wall member 21 are not connected, the connection portion 433 and the non-connection portion 434 being arranged alternately along an extension direction of the third fixing member 43.

With the above configuration (11), since the third sound absorbing material 33 is further provided, the noise and vibration transmitted in the thickness direction Dt of the outer wall member 21 is effectively reduced. Additionally, with the above configuration (11), since the connection portion 433 and the non-connection portion 434 are alternately arranged along the extension direction of the third fixing member 43, the transmission of noise and vibration between the third fixing member 43 and the outer wall member 21 is reduced, so that the noise and vibration transmitted in the thickness direction Dt of the outer wall member 21 is effectively reduced.
(12) In some embodiments, in the above configuration (11), a dimension (thickness t1) of the first sound absorbing material 31 in the thickness direction Dt may be larger than a dimension (thickness t3) of the third sound absorbing material 33 in the thickness direction Dt.

With the above configuration (12), it is possible to reduce the dimension from the outer wall member 21 to the other side in the thickness direction Dt while effectively reducing the noise and vibration transmitted through the soundproof device 30 for the duct in the thickness direction Dt. When the soundproof device 30 with the configuration (12) is arranged such that the other side faces the inside of the duct, it is easier to secure the cross-sectional area of the flow path for fluid flowing in the duct, thus reducing the effect on the flow rate of the fluid flowing in the duct.
(13) An intake duct 15 for a compressor 11 of a gas turbine 10 according to at least one embodiment of the present disclosure is provided with a duct (intake duct 15) with the soundproof device 30 having any one of the configurations (1) to (12) arranged such that a surface 51b of the first plate member 51 on the other side in the thickness direction Dt faces an inner side of the intake duct 15.

With the above configuration (13), it is possible to effectively reduce the transmission of the air intake sound from the compressor 11 to the outside.

1. A soundproof device for a duct, comprising:
a first sound absorbing material disposed on one side of an outer wall member of the duct in a thickness direction of the outer wall member;
a first fixing member to fix the first sound absorbing material to the outer wall member;
a first plate member located on the one side of the first sound absorbing material with an air layer interposed therebetween;
a second fixing member to fix the first plate member to the outer wall member; and
a second sound absorbing material disposed on the one side of the first plate member.

2. The soundproof device for the duct according to claim 1, comprising:
a second plate member covering the second sound absorbing material from the one side; and
a connection member disposed between the first plate member and the second plate member to connect the first plate member and the second plate member,
wherein the connection member is a Z-shaped plate material that includes a first part extending along a surface of the first plate member on the one side, a second part extending along a surface of the second plate member on the other side in the thickness direction, and a third part extending between the first part and the second part along the thickness direction.

3. The soundproof device for the duct according to claim 2,
wherein the first plate member and the first part are joined by a screw part or a rivet, and
wherein the second plate member and the second part are joined by a screw part or a rivet.

4. The soundproof device for the duct according to claim 2,
wherein the number of the connection members arranged is not more than three per square meter of the first plate member.

5. The soundproof device for the duct according to claim 2, comprising a sound insulation sheet attached to the surface of the second plate member on the other side.

6. The soundproof device for the duct according to claim 2,
wherein the second fixing member includes a bolt extending in the thickness direction, and
wherein an end portion of the bolt on the one side is located on the other side of the second plate member in the thickness direction at a distance from the second plate member.

7. The soundproof device for the duct according to claim 1, comprising a reinforcement member attached to the one side of the outer wall member and extending in a direction perpendicular to the thickness direction.

8. The soundproof device for the duct according to claim 7,
wherein the second fixing member includes a bolt extending in the thickness direction and the reinforcement member, and
wherein an end portion of the bolt on the other side in the thickness direction is fixed to the reinforcement member.

9. The soundproof device for the duct according to claim 1,
wherein the second fixing member includes a bolt extending in the thickness direction, and
wherein the first plate member is fixed to the bolt by nuts via elastic members on both a surface on the one side and a surface on the other side in the thickness direction.

10. The soundproof device for the duct according to claim 1,
wherein a dimension of the first sound absorbing material in the thickness direction is larger than a dimension of the second sound absorbing material in the thickness direction.

11. The soundproof device for the duct according to claim 1, comprising:
a third sound absorbing material disposed on the other side of the outer wall member in the thickness direction;
a third fixing member extending in a direction perpendicular to the thickness direction to fix the third sound absorbing material to the outer wall member; and
a third plate member covering the third sound absorbing material from the other side and fixed to the third fixing member,
wherein the third fixing member has a connection portion where the third fixing member and the outer wall member are connected and a non-connection portion where the third fixing member and the outer wall member are not connected, the connection portion and the non-connection portion being arranged alternately along an extension direction of the third fixing member.

12. The soundproof device for the duct according to claim 11,
wherein a dimension of the first sound absorbing material in the thickness direction is larger than a dimension of the third sound absorbing material in the thickness direction.

13. An intake duct for a compressor of a gas turbine, comprising
a duct with the soundproof device according to claim 1 arranged such that a surface of the first plate member on the other side in the thickness direction faces an inner side of the intake duct.
